(19) United States
(12) Patent Application Publication
(10) Pub. No.: US 2004/0222614 A1
(43) Pub. Date: Nov. 11, 2004

(54) Weight distributing ball mount head for a hitch assembly

(76) Inventors: Thomas W. Lindenman, South Bend, IN (US); Richard W. McCoy, Granger, IN (US)

Correspondence Address: KING & SCHICKLI, PLLC, 247 NORTH BROADWAY, LEXINGTON, KY, 40507, US

(21) Appl. No.: 10/430,620

(22) Filed: May 6, 2003

(51) Int. Cl. B60D 1/00

(52) U.S. Cl. 280/455.1

(57) ABSTRACT

An improved ball mount head is intended for use in a weight distributing hitch assembly for towing a trailer behind a vehicle. In one embodiment, the ball mount head includes at least one pair of substantially aligned sockets for receiving a mounting trunnion associated with a spring bar. At least one of the sockets in the aligned pair is substantially C-shaped to permit easy, tilt-in mounting of the corresponding spring bar. Additionally, the ball mount head may be positioned at a selected tilt angle to aid in distributing the tongue weight of the trailer between the front and rear wheels of the vehicle. To fix the tilt angle, an interlocking relationship is formed between a serrated portion of the ball mount head and a washer having a matching side face associated with a connector for connecting the ball mount head to the hitch bar.

### TECHNICAL FIELD

The present invention relates generally to the towing field and, more particularly, to a new and improved ball mount head for intended use in a weight distributing hitch assembly.

### BACKGROUND OF THE INVENTION

Hitch assemblies for evenly distributing the tongue weight of a trailer over the front and rear wheels of a towing vehicle are well known in the art. A particularly advanced weight distributing hitch assembly is disclosed in commonly assigned U.S. Pat. No. 5,375,867, entitled “Weight Distributing Hitch,” the disclosure of which is incorporated herein by reference. This assembly includes a hitch bar for mounting to the vehicle and a ball mount head for mounting on the hitch bar at a selected tilt angle. A pair of spring bars mounted to the ball mount head distribute the weight of the trailer relative to the vehicle. Each spring bar is substantially L-shaped and includes a turned groove at a proximal end received in a cooperating aperture in an upper platform of the ball mount head. A retainer of spring steel engages in the grooves to hold the spring bars in position.

While this hitch assembly is successful from a commercial standpoint, the number of parts required to attach the ball mount head and the spring bars increases the complexity and installation time. This arrangement is also considered by some to lack aesthetic appeal, primarily because the ends of the spring bars pass through the upper platform of the ball mount head and are, thus, exposed to view. The spring bar retainer is also positioned near the area where the trailer tongue and coupler are positioned over the hitch ball, thus leaving little room for clearance. The spring bar retainer is also easily lost or misplaced.

In an effort to reduce the complexity, ease the installation process, provide a more aesthetically pleasing design, and increase the overall service life, an improved type of weight distributing hitch assembly is proposed in commonly assigned U.S. Pat. No. 5,562,298, also incorporated herein by reference. One of the many advantageous features of this hitch assembly is that the ball mount head includes pairs of substantially aligned, sockets, with one in each pair being oblong and including a channel for receiving a pivot pin on the mounting trunnion associated with the corresponding spring bar. As a result of this arrangement, the spring bars may be easily installed in the ball mount head in a “tilt-in” fashion in a matter of seconds without the need for separate retainers, clips, fasteners or the like. The C-shaped socket also prevents the pivot pin from passing through the channel and falling out of the ball mount head in the event the free hanging weight of the spring bar causes the corresponding mounting trunnion to rock forward prior to connection to the trailer.

An advantageous feature of the hitch assemblies shown in both the '867 and '298 patents is the ability of the ball mount head to pivot relative to the hitch bar to adjust the tilt angle. Specifically, a first, lower connector, such as a bolt, extends through a lower portion of the hitch bar and aligned apertures in spaced flanges forming part of the ball mount head to create a pivot point. A second, upper connector passes through a corresponding portion of the hitch bar and aligned slots also formed in the spaced flanges of the ball mount head. Once the ball mount head is pivoted about the first connector to the selected tilt angle, indexable washers held on the second connector are selectively reoriented so that one side thereof engages a cooperating stop on the ball mount head. A fastener is then used to hold each washer in place, thereby fixing the tilt angle. As explained in detail in both patents, the ability to adjust the tilt angle of the ball mount head aids in properly distributing the tongue weight of the trailer relative to the vehicle.

While these arrangements both permit the reliable adjustment of the tilt angle of the ball mount head and, thus, overcome the problems associated with many past proposals, limitations remain. For example, the indexable washers somewhat limit the ability to fine tune the tilt angle of the ball mount head, since the positions available are limited by the size and shape (eccentricity) of the washer used and thus, are not infinitely adjustable. Simultaneously aligning indexable washers on both sides of the ball mount head in the proper position while tightening a fastener to secure both in place can be found by some users to be difficult and time consuming. Again, despite the fact that these arrangements generally work well for their intended purpose and are successful from a commercial standpoint, further reducing the assembly time and easing the overall installation procedure is desirable.

A different type of weight distributing hitch assembly is shown in U.S. Pat. No. 4,033,601 to Lindahl et al., which issued in 1977. This assembly includes a ball mount head in which serrations surround the slot formed in each flange of the mounting bracket. Washers with matching, serrated side faces are positioned on the upper connector (bolt) on either side of the flanges. Thus, once the ball mount head is pivoted to the desired tilt angle, the matching side faces of the washers are moved into cooperating engagement with the serrations on the ball mount head to create an interlocking relationship. By tightening a fastener on the connector, the position of the ball mount head is fixed at the desired tilt angle.

As should be appreciated, at least three significant advantages are afforded by this approach. First of all, the close spacing of the serrations makes it possible to precisely adjust the position of the upper connector along the corresponding slots to finely tune the tilt angle of the ball mount head. Secondly, the interlocking relationship achieved between the serrations prior to tightening the fastener on the connector also eases the installation procedure by eliminating the need for simultaneously adjusting indexable washers positioned on both sides of the ball mount head.

Despite these significant advantages, the ball mount head of the hitch assembly shown in the '601 patent is limited in at least one important respect. Specifically, instead of employing the advantageous, tilt-in mounting feature for the spring bars, the ball mount head includes displaceable “triggers” for holding the spring bars in place. As known in the art, the triggers must be manually pivoted during installation of the spring bars. Some users find this inconvenient and an unnecessary complication of the installation procedure. Triggers also add to the manufacturing expense.

Despite the convenience that would seemingly be afforded by the tilt-in mounting of the spring bars and the use of serrations to permit fine tuning of the tilt angle of the ball mount head, in the twenty-five years since the '601 patent issued, no one has proposed combining these features. Accordingly, a need is identified for a new and improved hitch assembly that combines the advantageous features of the foregoing prior art proposals, but eliminates the disadvantages. Specifically, a ball mount head capable of receiving the mounting trunnion associated with a spring bar in a “tilt-in” fashion for easy and efficient installation would form part of the assembly. Likewise, serrations would be provided adjacent to at least one of the slots in the ball mount head for receiving the corresponding connector. The serrations would allow the installer to adjust the tilt angle of the ball mount head relative to the hitch bar as desired and then form an interlocking relationship with a mating structure associated with the corresponding connector. Overall, the ball mount head and hitch assembly incorporating it would be as trustworthy and reliable as those disclosed in the above-identified prior patents, yet would provide further improvement in terms of ease of use, installation efficiency, and durability.

### SUMMARY OF THE INVENTION

In accordance with a first aspect of the invention, a ball mount head for intended use in a weight distributing hitch assembly for towing a trailer behind a vehicle is disclosed. The hitch assembly further includes a hitch bar, at least one connector for connecting the hitch bar to the ball mount head, and at least one mounting trunnion for supporting a spring bar. The ball mount head comprises a mounting bracket adapted for mounting to the hitch bar. The mounting bracket includes a serrated portion formed adjacent to a first slot for receiving the connector. First and second spaced platforms with first and second substantially aligned sockets are supported by the mounting bracket. Each socket is adapted for receiving and holding the mounting trunnion, with at least one of the sockets being substantially C-shaped to permit easy, tilt-in mounting of the corresponding spring bar.

In one embodiment, the first platform is an upper platform and a pair of first sockets is formed therein, each being substantially circular in outline. A matching pair of second sockets are formed in the second, lower platform. Each of the second sockets is substantially C-shaped and in alignment with one of said pair of first sockets. Hence, the first and second mounting trunnions are received in the pairs of first and second sockets. Preferably, each substantially C-shaped second socket is an elongated, generally arcuate channel. The channel opens in a forward direction toward the vehicle and defines a rearward lip for engaging the mounting trunnion in the operative position.

The mounting bracket is preferably U-shaped and includes first and second spaced flanges. Preferably, the first slot is formed in the first flange and a second slot substantially aligned with the first slot is formed in the second flange. The second flange includes a serrated portion formed on an outer side face thereof adjacent to the second slot. Both serrated portions include a plurality of generally vertically extending, substantially V-shaped teeth that completely surround the corresponding slot, but do not extend to a top edge of the corresponding flange. The serrated portion may extend above a surrounding outer surface of each corresponding flange. Optionally, the teeth may be oriented at an angle relative to a vertical plane.

In accordance with a second aspect of the invention, a weight distributing hitch assembly for towing a trailer behind a vehicle is provided. The assembly comprises a hitch bar for mounting to the vehicle and a ball mount head for mounting on the hitch bar at a selected tilt angle. The ball mount head includes a serrated portion formed adjacent to at least one slot. A connector is provided for connecting the hitch bar to the ball mount head through the slot. A structure, such as a washer, associated with the connector includes a side face adapted for mating with the serrated portion to fix the tilt angle of the ball mount head. At least one spring bar is provided for at least partially distributing the weight of the trailer relative to the vehicle. The spring bar includes a mounting trunnion, and the ball mount head includes first and second spaced, substantially aligned sockets for receiving and holding the spring bar by the mounting trunnion. At least one of the sockets is substantially C-shaped to permit tilt-in mounting of the spring bar.

In one embodiment, the ball mount head includes a mounting bracket having first and second spaced flanges defining a yoke for receiving a portion of the hitch bar. The first slot is formed in the first flange and a second slot substantially aligned with the first slot is formed in the second flange. Preferably, the ball mount head is pivotably mounted to the hitch bar and the structure is a first washer positioned on the connector adjacent to the serrated portion on the first flange. A fastener is also positioned on the connector to hold the side face of the first washer in interlocking engagement with the first serrated portion. A second serrated portion may be formed adjacent to the second slot, and a second washer including a side face for mating with the second serrated portion may be positioned on the connector.

The weight distributing hitch assembly may include first and second spring bars, each associated with a mounting trunnion. The ball mount head may further include a pair of first sockets for receiving the mounting trunnion of the first spring bar and a pair of second sockets for receiving the mounting trunnion of the second spring bar. Preferably, the first sockets are substantially circular in outline and the second sockets are each C-shaped and form an elongated channel that opens in a forward direction toward the vehicle. Each channel may include a sidewall defining a rearward lip for engaging the lower portion of the mounting trunnion when moved rearward in the channel. The sidewall is preferably contoured for engaging the mounting trunnion when the corresponding spring bar is urged toward the mounting bracket.

### BRIEF DESCRIPTION OF THE DRAWINGS

The accompanying drawings incorporated in and forming apart of the specification illustrate several aspects of the present invention and, together with the description, serves to explain the principles of the invention. In the drawings:

FIG. 1 is a partially cutaway, exploded perspective view of a weight distributing hitch assembly including a ball mount head constructed in accordance with the principles of the present invention;

FIG. 2 is a side elevational view of one possible embodiment of a ball mount head showing the serrated portion adjacent to the slot for mating with the side face of a corresponding structure, such as a washer, for fixing the tilt angle;

FIG. 3 is a cutaway side elevational view illustrating the manner of installing a spring bar mounting trunnion in the ball mount head;

FIG. 4 is a cross-sectional view taken along line 4-4 of FIG. 8, showing the contour of a pair of aligned sockets for receiving the mounting trunnion of the spring bar;

FIG. 5 is a partially cross-sectional bottom plan view taken along line 5-5 of FIG. 2, showing the sockets formed in the upper platform of the ball mount head;

FIG. 6 is a partially cross-sectional top plan view taken along line 6-6 of FIG. 2, showing the sockets formed in the lower platform of the ball mount head;

FIG. 7 is a side elevational view showing the ball mount head coupled to the hitch bar at a selected tilt angle; and

FIG. 8 is a partially exploded top plan view showing the hitch bar received in the ball mount head, the upper connector, and the washers used to fix the tilt angle in the preferred embodiment.

Reference will now be made in detail to the present preferred embodiment of the invention, an example of which is illustrated in the accompanying drawing.

### DETAILED DESCRIPTION OF THE INVENTION

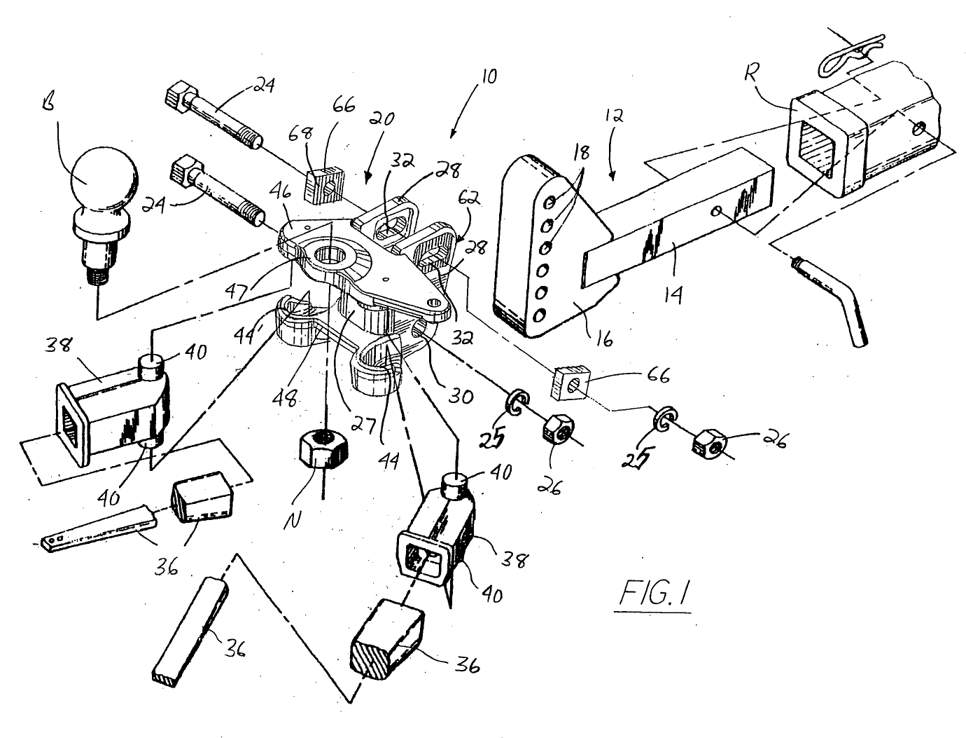

Reference is now made to FIG. 1 showing the weight distributing hitch assembly 10 of the present invention. As should be appreciated, the hitch assembly 10 includes a hitch bar 12 of a type known in the art including a tubular mounting post 14 for engagement in a receiver box R of a hitch receiver mounted to a vehicle (not shown). Such a hitch receiver is, for example, a Class III or Class IV hitch receiver manufactured by Reese Products, Inc. of Elkhart, Ind., the assignee of the present invention.

The distal end of the hitch bar 12 includes a mounting rack 16 having a series of apertures 18 allowing for height adjustment of the ball mount head 20. The ball mount head 20 may be a one-piece, integral construction cast from ductile iron, or may be comprised of separate pieces of metal welded together. The ball mount head 20 is secured to the mounting rack 16 of the hitch bar 12 by means of two cooperating fasteners, which are shown for purposes of illustration as bolts 24, cooperating nuts 26 and lock washers 25.

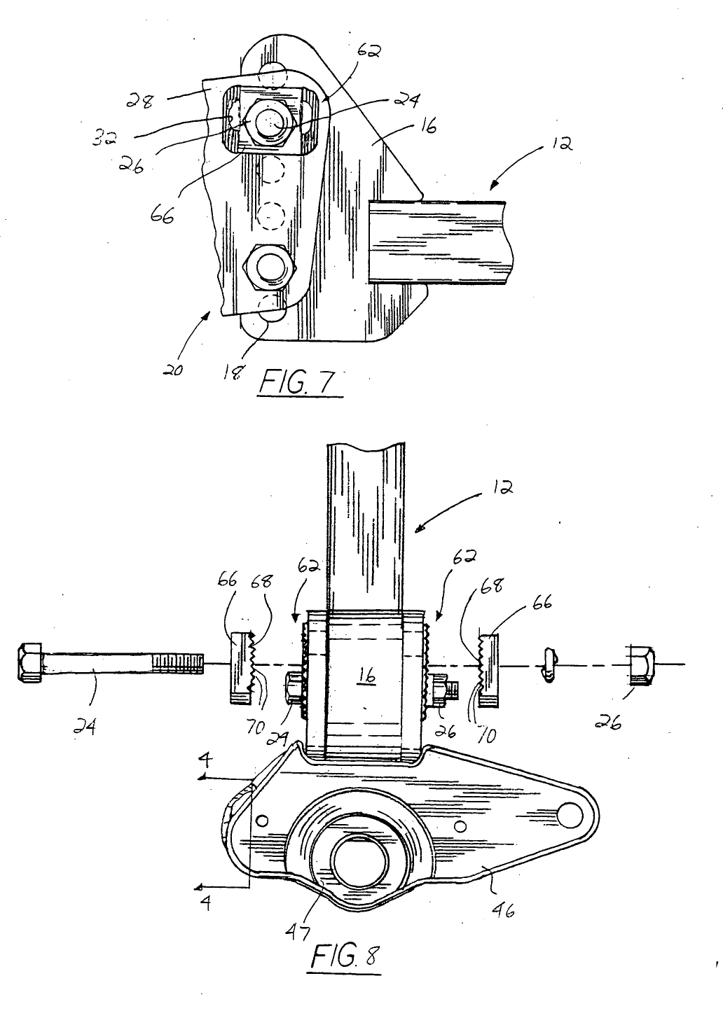

The ball mount head 20 includes a substantially U-shaped mounting bracket 27 having a pair of spaced, parallel mounting flanges 28 so as to form a yoke adapted to receive the mounting rack 16 (see FIG. 7). When properly mounted, the lower bolt 24 extends through the aligned cooperating apertures 30 (only one visible in FIG. 1) in the mounting flanges 28 and the one aligned aperture 18 in the mounting rack 16. Upper bolt 24 extends through aligned cooperating arcuate slots 32 in the mounting flanges 28 and through the aligned aperture 18 in the mounting rack 16. As described in detail further below, the arcuate slots 32 allow for pivoting of the ball mount head 20 about lower bolt 24. As should be appreciated, this pivoting movement allows the user to adjust the tilt angle of the ball mount head 20 relative to the hitch bar 12.

As also shown in FIG. 1, the hitch assembly 10 includes a pair of spring bars 36 for aiding in distributing the tongue weight of the trailer relative to the front and rear wheels of the towing vehicle. Each spring bar 36 includes a trunnion 38 at its proximal end for mounting in the ball mount head 20. More specifically, each mounting trunnion 38 includes a pair of oppositely disposed and outwardly projecting pivot pins 40. As described in greater detail below, the pivot pins 40 on the trunnion 38 of the first spring bar 36 are received in a first set of cooperating sockets 42, 44 in the ball mount head 20 while the pivot pins 40 on the trunnion 38 of the second spring bar 36 are received in a second set of cooperating sockets 42′, 44′ also in the ball mount head (see also FIGS. 3-6).

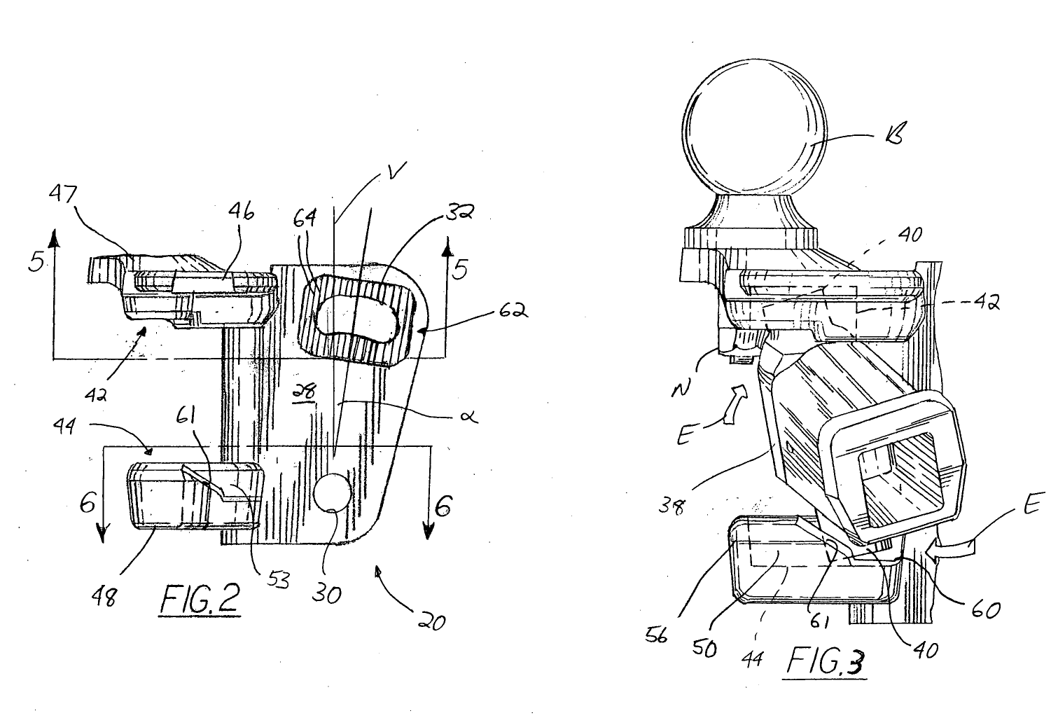

As further shown in FIGS. 1 and 2, the ball mount head 20 includes spaced, substantially parallel first and second plates or platforms 46, 48, respectively, that may be integrally cast with the mounting bracket 27 or securely attached thereto, such as by welding. In one embodiment, the first socket 42, 42′ of each set of sockets is substantially circular in outline and formed in the upper or first platform 46 (see FIGS. 2 and 5). The upper platform 46 may also include a raised portion 47 having an aperture for receiving the stem of the hitch ball B. Preferably, the sockets 42, 42′ are spaced apart to the sides of this raised portion 47 to create a clearance space for receiving a tool, such as a wrench, used to tighten a nut N on the corresponding threaded stem of the hitch ball B.

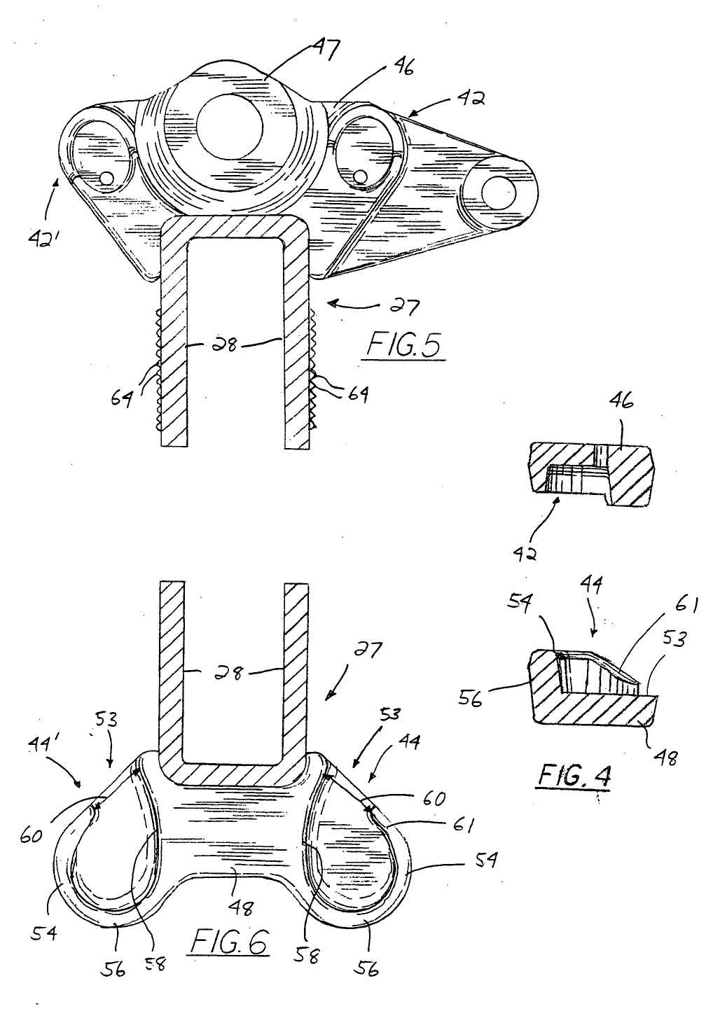

In accordance with a first aspect of the invention, the second socket 44, 44′ of each set is generally C-shaped. In the embodiment shown in the drawings, each generally C-shaped second socket 44, 44′ is an elongated channel 53 formed in the upper face of the lower or second platform 48; that is, the face directed toward the first platform 46 (see FIGS. 2 and 6). This channel 53 includes a sidewall 54 that defines a rearward lip 56 for engaging the mounting trunnion 38 when positioned in the respective sockets 42, 44 and 42′, 44′ (see FIG. 4). As perhaps best shown in FIG. 6, the portion 58 of the sidewall 54 defining the side of the channel 53 adjacent to the mounting bracket 27 is arcuate or curved. Thus, as described in more detail below, when the mounting trunnion 38 is engaged in the respective sockets 42, 44 and 42, 44′ and urged in the direction of the bracket 27 (i.e., towards the vehicle), the corresponding pivot pin 40 frictionally engages this curved portion 58 of the sidewall 54 and prevents it from moving out of the channel 53.

As should be appreciated, because of the C-shape, the channel 53 forming each second socket 44, 44′ is open-ended. Preferably, each channel 53 is oriented such that the open end 60 is directed toward the forward portion of the lower platform 48, generally in the direction of the hitch receiver R or the vehicle to which it is attached. Accordingly, the spring bar 36 is installed in the ball mount head 20 of the hitch assembly 10 by inserting a first end or pivot pin 40 of the mounting trunnion 38 in the first socket 42. The spring bar 36 is then manipulated so as to be canted slightly (bottom end tilted away from the center of ball mount head 20; see FIG. 3) for passing the second end or opposite pivot pin 40 through the open end 60 of the corresponding channel 53. As shown in FIGS. 2-4, the outer top portion 61 of the sidewall 54 adjacent to the open end 60 may be tapered relative to the horizontal plane to facilitate initial entry of the corresponding pivot pin 40 into the channel 53.

Next, the spring bar 36 is twisted so that the corresponding pivot pin 40 follows the channel 53 (see action arrows E in FIG. 3), passing along the curved sidewall 54 until engagement with the rearward lip 56 is made. As should be appreciated, the curved side portion 58 of the sidewall 54 helps to insure that the spring bar 36 is guided to the proper mounted position, fully engaged in the sockets 42, 44 of the ball mount head 20. As mentioned above, this side portion 58 also provides an engagement surface for the pivot pin 40 of the mounting trunnion 38. This engagement surface prevents the pivot pin 40 from passing through the channel 53 and falling out of the ball mount head 20 in the event that the free-hanging weight of the spring bar 36 causes it to rock forward (i.e., toward the vehicle) prior to connection to the trailer. The other spring bar 36 is then inserted in the sockets 42′, 44′ on the opposite side of the ball mount head 20 in the same “tilt-in” manner. As should be appreciated, removal of the spring bars 36 is effected by simply reversing the above-described procedures.

In accordance with a second aspect of the invention, the tilt angle of the ball mount head 20 relative to the hitch bar 12 is selectively adjustable, depending on the desired distribution of weight between the front and rear wheels of the vehicle. Specifically, with reference to FIGS. 2, 7, and 8, each flange 28 on the ball mount head 20 includes a serrated portion 62 adjacent to the arcuate slot 32 formed therein. As perhaps best shown in FIG. 2, the serrated portion 62 preferably comprises a plurality of generally vertically extending, parallel, V-shaped teeth 64 fully surrounding each arcuate slot 32. A matching structure, such as a washer 66 having a side face 68 with cooperating serrations 70, is positioned on each side of the upper bolt 24, adjacent to the serrated portion 62.

To adjust the tilt angle, the upper bolt 24 is moved along the arcuate slots 32, with the lower bolt 24 defining a pivot point for the ball mount head 20. Once the desired tilt angle is reached, the corresponding side face 68 of each washer 66 is moved into an interlocking relationship with the corresponding serrations 62 on the adjacent face of each flange 28. As should be appreciated, the close lateral spacing of the teeth 64 forming the serrations 62 permit the installer to fine tune the tilt angle, and also allow for easy repositioning to adjust this angle, if necessary or desired. Once the interlocking relationship is established, the nut 26 is then tightened on the upper bolt 24 to fix the tilt angle and hold the ball mount head 20 securely in position (see FIG. 7). As should be appreciated, subsequent adjustments to the tilt angle may be made by loosening the nut 26 associated with the upper bolt 24 and simply repositioning the washers 66.

As a result of this combination of features, not only is the installation procedure very simple and straightforward, but the ease of adjustability and overall service life are also improved. The cooperation between each serrated portion 62 and the corresponding structure, such as mating washer 66, makes it possible to precisely select or fine tune the tilt angle. Fixing the ball mount head 20 in place and making subsequent positional adjustments are both also facilitated using this arrangement, as compared to the use of indexable washers or the like. It is also not necessary to remove the upper bolt 24 to select or make an adjustment to the tilt angle; rather, loosening the corresponding nut 26 is all that is required to permit the adjustment to be made.

Additionally, the retention of the spring bars 46 is advantageously achieved without the use of any pivoting trigger, retaining pin, clip or other component of the type used in prior art designs. Consequently, neither manipulating a trigger to mount the spring bar nor struggling to hold the spring bar in position while inserting a retaining pin or clip is required. Moreover, since retaining pins, clips and triggers are all closely positioned near the hitch ball B, in prior art arrangements, the elimination of these structures increases the clearance for the connection of the trailer. Despite the absence of triggers, clips or retaining pins, the pivot pins 40 are still held securely in the sockets 42, 44 and 42′, 44′, even before the spring bars 36 are placed under load by connection through chains to lift units on the trailer frame (not shown) in a manner known in the art. This is accomplished through the frictional engagement of the pivot pins 40 with the sidewall 54 of the elongated channel 53 forming the second socket 44, 44′.

As best shown in FIG. 8, the teeth 64 may project above the adjacent outer surface of the flange 28 instead of being recessed, as shown in the '601 patent, so as to form part of an elevated pad. This facilitates establishing the interlocking relationship with the corresponding side face 68 of each washer 66. Also, since the range of tilt angles is limited by the length of the arcuate slots 32, the teeth 64 only need extend a sufficient distance to engage the side face 68 of the corresponding washer 66 when the upper bolt 24 reaches the terminal ends of the slots. Consequently, the teeth 64 do not necessarily need to extend to the adjacent lateral side edge of the flange 28. Likewise, when the slots 32 are oriented as shown in the drawing figures, the teeth 64 need only extend a sufficient distance in the vertical direction to engage the corresponding portion of the side face of each washer 66. Thus, as perhaps best shown in FIG. 2, the teeth 66 need not extend to the top edge of the flange 28, either. It is noted that in this figure, the teeth 64 are also shown as extending at a slight angle (e.g., 10°) relative to a vertical plane V (see angle α in FIG. 2). This feature facilitates alignment of the washers 66 when the ball mount head 20 is in the center position (that is, when it is oriented as shown in FIG. 7), but is considered optional.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, while the sockets 44, 44′ are shown as channels 53 that open forward, toward the vehicle, the opening could extend in other directions, such as substantially perpendicular to the direction of travel. The C-shaped sockets 44, 44′ could also be formed in the upper platform 46. The embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with breadth to which they are fairly, legally and equitably entitled.

1. A ball mount head for intended use in a weight distributing hitch assembly for towing a trailer behind a vehicle, said assembly further including a hitch bar, at least one connector for connecting the hitch bar to the ball mount head, and at least one mounting trunnion for supporting a spring bar, comprising:
a mounting bracket adapted for mounting to the hitch bar, said mounting bracket including a serrated portion formed adjacent to a first slot for receiving the connector; and
first and second spaced platforms supported by the mounting bracket and including first and second substantially aligned sockets, each adapted for receiving and holding the mounting trunnion, at least one of said sockets being a substantially C-shaped open channel to permit tilt-in mounting of the corresponding spring bar.

2. The ball mount head of claim 1, wherein the first platform is an upper platform and a pair of first sockets is formed therein, each of said first sockets being substantially circular in outline.

3. The ball mount head of claim 2, wherein a pair of second sockets are formed in the second, lower platform, each of said second sockets being a substantially C-shaped open channel and substantially aligning with one of said pair of first sockets, wherein first and second mounting trunnions are received in the pairs of first and second sockets, respectively.

4. The ball mount head of claim 3, wherein each of said open channels is elongated, generally arcuate and opens in a forward direction, said channel having a rearward lip for engaging the mounting trunnion in the operative position.

5. (Cancelled).

6. The ball mount head of claim 1, wherein the mounting bracket is U-shaped and includes first and second spaced flanges, the first slot being formed in the first flange and a second slot substantially aligned with the first slot being formed in the second flange.

7. The ball mount head of claim 6, wherein the second flange includes a serrated portion formed on an outer side face thereof adjacent to the second slot.

8. The ball mount head of claim 7, wherein each serrated portion includes a plurality of generally vertically extending, substantially V-shaped teeth that completely surround the corresponding slot, but do not extend to a top edge of the corresponding flange.

9. The ball mount head of claim 7, wherein the serrated portion extends above a surrounding outer surface of each corresponding flange.

10. The ball mount head of claim 1, wherein the serrated portion includes a plurality of teeth, wherein the teeth are oriented at an angle relative to a vertical plane.

11-21. (Canceled).

22. A ball mount head for intended use in a weight distributing hitch assembly for towing a trailer behind a vehicle, said assembly further including a hitch bar, at least one connector for connecting the hitch bar to the ball mount head, and at least one mounting trunnion for supporting a spring bar, comprising:
a mounting bracket adapted for mounting to the hitch bar, said mounting bracket including a serrated portion formed adjacent to a first slot for receiving the connector, said serrated portion including a plurality of substantially V-shaped teeth oriented at an angle relative to the vertical plane; and
first and second spaced platforms supported by the mounting bracket and including first and second substantially aligned sockets, each adapted for receiving and holding the mounting trunnion, at least one of said sockets being an open channel to permit tilt-in mounting of the corresponding spring bar.

23. The ball mount head of claim 22, wherein said angle is less than 10°.

24. The ball mount head of claim 22, wherein said serrated portion does not engage a top edge of said mounting bracket.

25. The ball mount head of claim 22, wherein said open channel is substantially C-shaped.
